(19) United States
(12) Patent Application Publication
(10) Pub. No.: US 2008/0024704 A1
(43) Pub. Date: Jan. 31, 2008

(54) LIQUID CRYSTAL DISPLAY PANEL

(75) Inventor: CHUN-YI HUANG, Taoyuan County (TW)

Correspondence Address: J C PATENTS, INC., 4 VENTURE, SUITE 250, IRVINE, CA, 92618, US

(73) Assignee: CHUNGHWA PICTURE TUBES, LTD., Taipei (TW)

(21) Appl. No.: 11/460,467

(22) Filed: Jul. 27, 2006

(51) Int. Cl. G02F 1/1337

(52) U.S. Cl. 349/123

(57) ABSTRACT

A LCD panel including a first substrate, a second substrate, a liquid crystal layer, a plurality of first alignment patterns, second alignment patterns and third alignment patterns provided. The LC layer is disposed between the first and second substrate. Multiple first, second and third sub-pixel regions are defined on the second substrate. The first alignment patterns are disposed inside the first sub-pixel regions along a first and a second direction where the first direction is at an angle θ₁ with the second direction; second alignment patterns disposed inside the second sub-pixel regions along a third and a fourth direction where the third direction is at angle θ₂ with the fourth direction; and third alignment patterns disposed inside the third sub-pixel regions along a fifth and a sixth direction where the fifth direction is at an angle θ₃ with the sixth direction is, and also θ₁≦θ₂<θ₃.

### BACKGROUND OF THE INVENTION

1. Field of the Invention

The present invention generally relates to a display panel. More particularly, the present invention relates to a multi-domain vertical alignment (MVA) liquid crystal display panel.

2. Description of Related Art

In recent years, due to matured semiconductor manufacturing techniques and optoelectronic technologies, the flat panel displays (FPDs) develop dramatically. For example, the liquid crystal displays (LCDs) owning the advantages of low voltage operation, being radiation-free, light weight and minimized volume have gradually replaced the traditional CRT display as the mainstream display products nowadays. However, the LCDs still suffer from the problem of narrow viewing angle. To solve this problem, various techniques for widening the viewing angle of displays were proposed and thereby a certain kinds of displays are offered such as twisted-nematic (TN) LCD together with the wide viewing film, in-plane switching (IPS) LCD, fringe field switching LCD, and multi-domain vertical alignment (MVA) LCD, etc.

FIG. 1 is a cross-sectional view schematically showing a conventional MVA LCD panel. Referring to FIG. 1, the conventional MVA LCD panel 100 mainly comprises a color filter substrate 110, a thin film transistor (TFT) array substrate 120, and a liquid crystal (LC) layer 130. Here, the color filter substrate 110 has a plurality of color filter patterns R10, G10, B10, and a plurality of alignment protrusions 112 thereon. These alignment protrusions 112 are used to change the direction of an electric field nearby, such that the liquid crystal molecules in the LC layer 130 appear as the multi-domain arrangement.

FIG. 2 is a top view schematically showing one single pixel of the LCD panel of FIG. 1, and FIG. 3 schematically shows a tilted liquid crystal molecule along one direction. Referring to FIGS. 2 and 3, one pixel of the LCD panel 100 can be divided into three sub-pixel regions 102, 104 and 106 according to disposed locations of color filter patterns R10, G10 and B10. After the backlight source of the LCD passes through the color filter patterns R10, G10 and B10, the red, green and blue lights are formed, respectively. Additionally, in order to obtain the maximum transmittance of light, it's required that the angle θ be 45 degrees as shown in FIG. 3 while applying a voltage used for tilting the liquid crystal molecules 132, where the angle θ is the angle between the long-axis direction C1 which the liquid crystal molecule 132 is projected on color filter substrate 110 and the axis C2, and where the axis C2 is parallel with the long side of each sub-pixel region 102, 104, and 106. Hence, the alignment protrusions 112 inside each sub-pixel region 102, 104, and 106 of the TFT LCD 100 are all arranged along the first direction A1 and the second direction A2 so as to maximize the transmittance rate of light. Here, the angle θ between the first direction A1 and the second direction A2 is 90 degrees so that the angle θ between the long-axis direction C1 and axis C2 is 45 degrees when the liquid crystal molecules 132 are tilted.

However, since the tilt arrangement of liquid crystal molecules 132 of the LC layer 130 is affected by the alignment protrusions 112 in displaying mid-tone images, the transmittance for lights with different wavelengths may differ, and the transmittance rate is higher for the light with a shorter wavelength. That is, the transmittance rate of blue light is larger than that of green light, and the transmittance rate of green light larger than that of red light. Therefore, the intensities for red, green and blue lights which are formed by the white light passing through the color filter patterns R10, G10 and B10 would lead to the problem of color shift for the LCD panel in displaying mid-tone images and deteriorate the displaying quality thereof.

### SUMMARY OF THE INVENTION

The object of the present invention is to provide a liquid crystal display panel for improving the color shift in displaying mid-tone images.

Based on the above object and other objects, the present invention provides a liquid crystal display panel comprising a first substrate, a second substrate, a liquid crystal layer, a plurality of first alignment patterns, a plurality of second alignment patterns and a plurality of third alignment patterns. The liquid crystal layer is disposed between the first substrate and the second substrate, and a plurality of first sub-pixel regions, a plurality of second sub-pixel regions, and a plurality of third sub-pixel regions are defined on the second substrate. Besides, a plurality of first alignment patterns are disposed inside the first sub-pixel regions along a first direction and a second direction wherein the first direction is at an angle θ₁ with the second direction; a plurality of second alignment patterns are disposed inside the second sub-pixel regions along a third direction and a fourth direction wherein the third direction is at an angle θ₂ with the fourth direction; and a plurality of third alignment patterns are disposed inside the third sub-pixel regions along a fifth direction and a sixth direction wherein the fifth direction is at an angle θ₃ with the sixth direction, and also θ₁≦θ₂<θ₃.

The above-mentioned liquid crystal display panel may further comprise a plurality of first color filter patterns disposed inside the first sub-pixel regions, a plurality of second color filter patterns disposed inside the second sub-pixel regions, and a plurality of third color filter patterns disposed inside the third sub-pixel regions. Wherein, the transmission wavelength of the first color filter patterns is greater than the transmission wavelength of the second color filter patterns, and the transmission wavelength of the second color filter patterns is greater than the transmission wavelength of the third color filter patterns.

In the liquid crystal display panel described above, the first color filter patterns are red color filter patterns, the second color filter patterns are green color filter patterns, and the third color filter patterns are blue color filter patterns, for example.

In the liquid crystal display panel described above, the first alignment patterns further comprise regions on the first substrate which is opposite to the first sub-pixel regions of the second substrate along the first direction and the second direction, the second alignment patterns further comprise regions on the first substrate which is opposite to the second sub-pixel regions of the second substrate along the third direction and the fourth direction, and the third alignment patterns further comprise regions on the first substrate which is opposite to the third sub-pixel regions of the second substrate along the fifth direction and the sixth direction.

In the liquid crystal display panel described above, the first substrate may further comprise a first transparent electrode layer disposed thereon and the second substrate may further comprise a second transparent electrode layer disposed thereon. Also, the first, the second and the third alignment patterns respectively comprise a plurality of protrusions disposed on the first transparent electrode layer and a plurality of slits formed in the second transparent electrode layer.

In the liquid crystal display panel described above, the first substrate may further comprise a first transparent electrode layer disposed thereon and the second substrate may further comprise a second transparent electrode layer disposed thereon. Also, the first, the second and the third alignment patterns respectively comprise a plurality of protrusions disposed on the second transparent electrode layer and a plurality of slits formed in the first transparent electrode layer.

In the liquid crystal display panel described above, the first, the second and the third alignment patterns are slits, for example. In addition, the material of the first, the second and the third alignment patterns, for example, is color filtering material, transparent photo-sensitive material or the combination thereof.

In the liquid crystal display panel described above, the first, the second and the third alignment patterns are protrusions, for example.

In the liquid crystal display panel described above, the angle θ₁ is equal to 90 degrees. In the liquid crystal display panel described above, the angle θ₂ for example is between 90 degrees and 120 degrees.

In the liquid crystal display panel described above, the angle θ₃ for example is between 110 degrees and 130 degrees.

In the liquid crystal display panel described above, the first substrate is a thin film transistor array substrate and the second substrate is a color filter substrate, for example.

From the descriptions above, the LCD panel according to the present invention is to arrange the alignment patterns inside the first, the second and the third sub-pixel regions along different directions, for improving the color shift phenomenon as result of different transmittance rates for lights with different wavelengths in the conventional technique, thereby raising the displaying quality of the LCD.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view schematically showing a conventional MVA LCD panel.

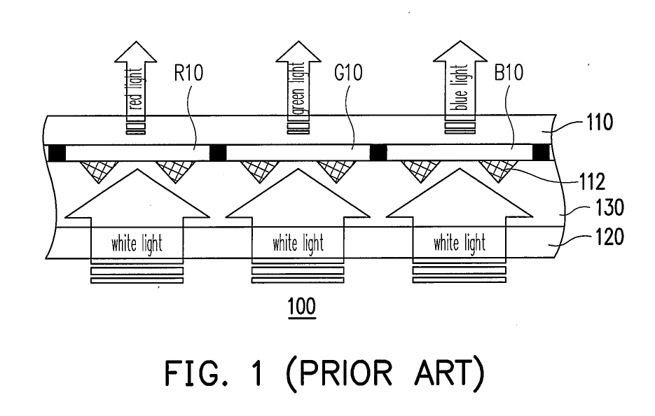

FIG. 2 is a top view schematically showing a single pixel of the LCD panel in FIG. 1.

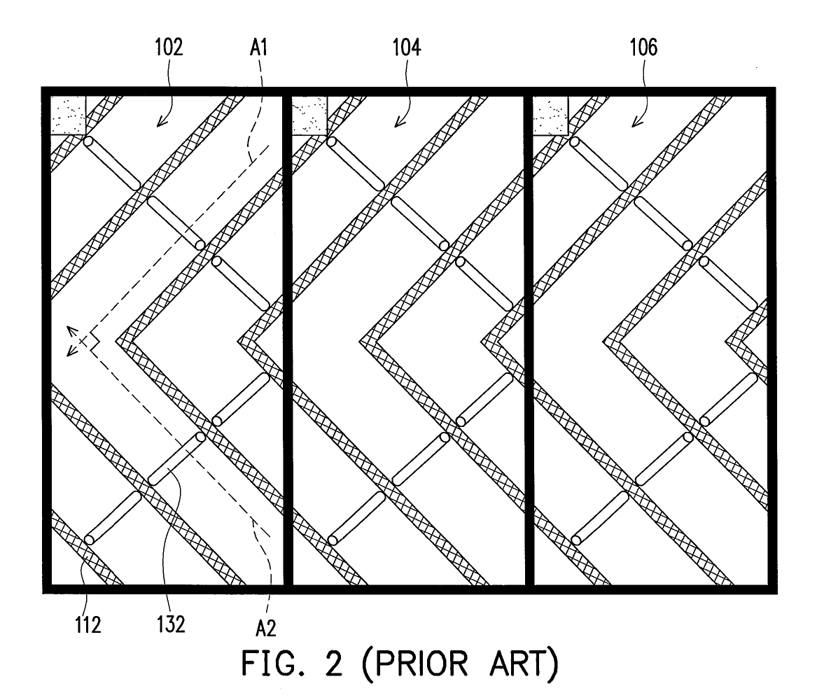

FIG. 3 schematically shows a tilted liquid crystal molecule along one direction.

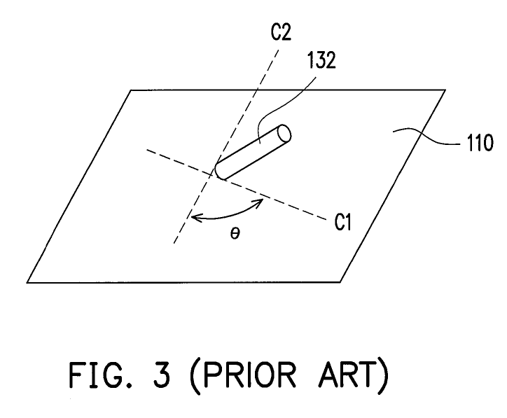

FIG. 4 is a top view schematically showing a single pixel of the LCD panel according to the first embodiment of the present invention.

FIG. 5 schematically shows a cross-sectional view taken along the line I-I′ in FIG. 4.

FIG. 6 is a cross-sectional view schematically showing another LCD panel according to the first embodiment of the present invention.

FIG. 7 is a top view schematically showing a single pixel of the LCD panel according to the second embodiment of the present invention.

FIG. 8 schematically shows a cross-sectional view taken along the line II-II′ in FIG. 7.

FIG. 9 is a top view schematically showing a single pixel of the LCD panel according to the third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### The First Embodiment

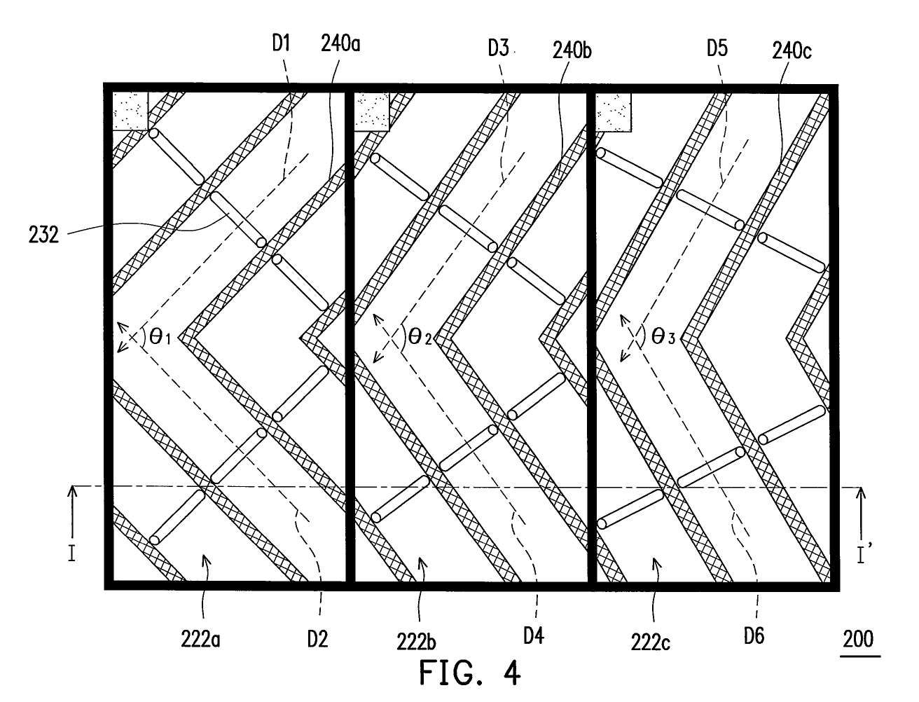

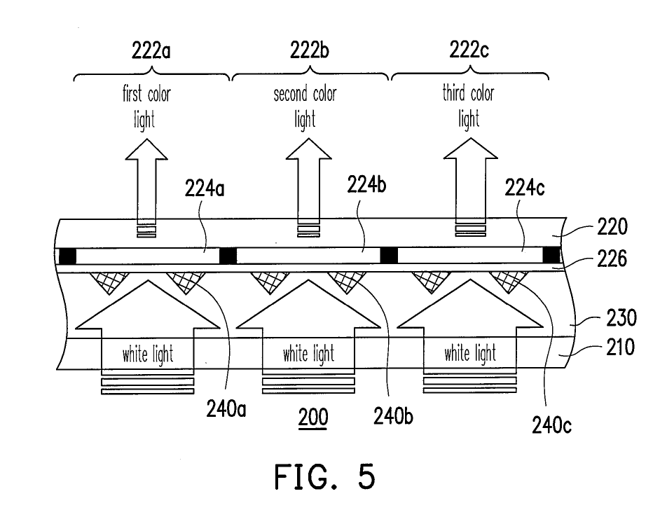

FIG. 4 is a top view schematically showing a single pixel of the LCD panel according to the first embodiment of the present invention, and FIG. 5 schematically shows a cross-sectional view taken along the line I-I′ in FIG. 4. Referring to FIGS. 4 and 5, the LCD panel 200 of the present embodiment comprises a first substrate 210, a second substrate 220, a liquid crystal (LC) layer 230, a plurality of first alignment patterns (e.g. the protrusion 240a), a plurality of second alignment patterns (e.g. the protrusion 240b), and a plurality of third alignment patterns (e.g. the protrusion 240c). The LC layer 230 is disposed between the first substrate 210 and second substrate 220. On the second substrate 220 are defined a plurality of first sub-pixel regions 222a, a plurality of second sub-pixel regions 222b, and a plurality of third sub-pixel regions 222c. Besides, a plurality of first alignment patterns are disposed in the first sub-pixel regions 222a along a first direction D1 and a second direction D2 wherein the first direction D1 is at an angle θ₁ with the second direction D2; a plurality of second alignment patterns are disposed in the second sub-pixel regions 222b along a third direction D3 and a fourth direction D4 wherein the third direction D3 is at an angle θ₂ with the fourth direction D4 is; and a plurality of third alignment patterns are disposed in the third sub-pixel regions 222c along a fifth direction D5 and a sixth direction D6 wherein the fifth direction D5 is at an angle θ₃ with the sixth direction D6, and also θ₁<θ₂<θ₃.

In the LCD panel 200 described above, the first substrate 210 is a thin film transistor (TFT) array substrate and the second substrate 220 is a color filter (CF) substrate, for instance. Besides, a plurality of first color filter patterns 224a disposed inside each first sub-pixel region 222a, a plurality of second color filter patterns 224b disposed inside each second sub-pixel region 222b and a plurality of third color filter patterns 224c disposed inside each third sub-pixel region 222c are further provided. Here, the transmission wavelength of the first color filter patterns 224a is greater than that of second color filter patterns 224b, and the transmission wavelength of the second color filter patterns 224b greater than that of third color filter patterns 224c. In this embodiment, the first color filter patterns 224a are red color filter patterns, the second color filter patterns 224b are green color filter patterns, and the third color filter patterns 224c are blue color filter patterns, for example.

As previously described, there is further provided a second transparent electrode layer 226 disposed on the second substrate 220 and covering the first, the second and the third color filter patterns 224a, 224b and 224c. The second transparent electrode layer 226 may be a common electrode and its material may be indium tin oxide (ITO), indium zinc oxide (IZO) or other transparent conductive materials. Further, the material of protrusions 240a, 240b and 240c may be color filter material, transparent photo-sensitive material or the combination thereof. In addition, the magnitude of angles θ₁, θ₂ and θ₃ is adjusted depending on the color of used color filter pattern. For instance, the angle θ₁ may be 90 degrees when the first color filter patterns 224a are red color filter patterns. The angle θ₂ may be greater than 90 degrees and smaller than or equal to 120 degrees, and preferably 116 degrees, when the second color filter patterns 224b are green color filter patterns. The angle θ₃ may be about 110 degrees to 130 degrees, and preferably 124 degrees, when the third color filter patterns 224c are blue color filter patterns.

Since the first, the second and the third alignment patterns (e.g. protrusions 240a, 240b and 240c) are arranged inside the first, the second and the third sub-pixel regions 222a, 222b and 222c respectively along different directions, the liquid crystal molecules 232 inside the LC layer 230 are arranged at different tilt angles. And therefore various wavelength-brightness distributions inside the first, the second and the third sub-pixel regions 224a, 224b and 224c can be formed after the white light passes through the LC layer 230. Furthermore, because the transmittance rates of the first, the second and the third sub-pixel regions 222a, 222b and 222c are varied for lights with different wavelengths, the wavelength distributions in the first, the second and the third sub-pixel regions 222a, 222b and 222c which match the transmittance rates of the first, the second and the third color filter patterns 224a, 224b and 224c can be obtained, such that the first color light (e.g. red light), the second color light (e.g. green light) and the third color light (e.g. blue light) with similar brightness are generated after the white light passes through the first, the second and the third sub-pixel regions 222a, 222b and 222c. By doing so, the phenomenon of color shift for the LCD panel 200 in displaying mid-tone images can be improved and the displaying quality can be raised accordingly.

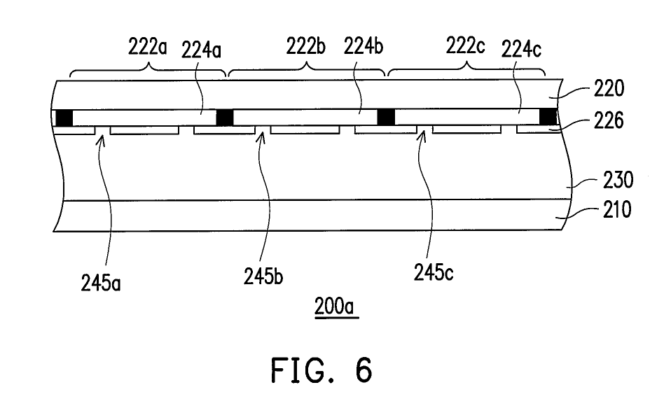

FIG. 6 is a cross-sectional view schematically showing another LCD panel according to the first embodiment of the present invention. Referring to FIG. 6, the LCD panel 200a is similar to the LCD panel 200 in FIG. 5, and the difference between them is as follows. For the LCD panel 200 the first, the second and the third alignment patterns are disposed on the protrusions 240a, 240b and 240c above the second transparent electrode layer 226, while for the LCD panel 200a the first, the second and the third alignment patterns are formed in the slits 245a, 245b, and 245c inside the second transparent electrode layer 226. In other words, the first, the second and the third alignment patterns may be protrusions or slits in the first embodiment, for example.

### The Second Embodiment

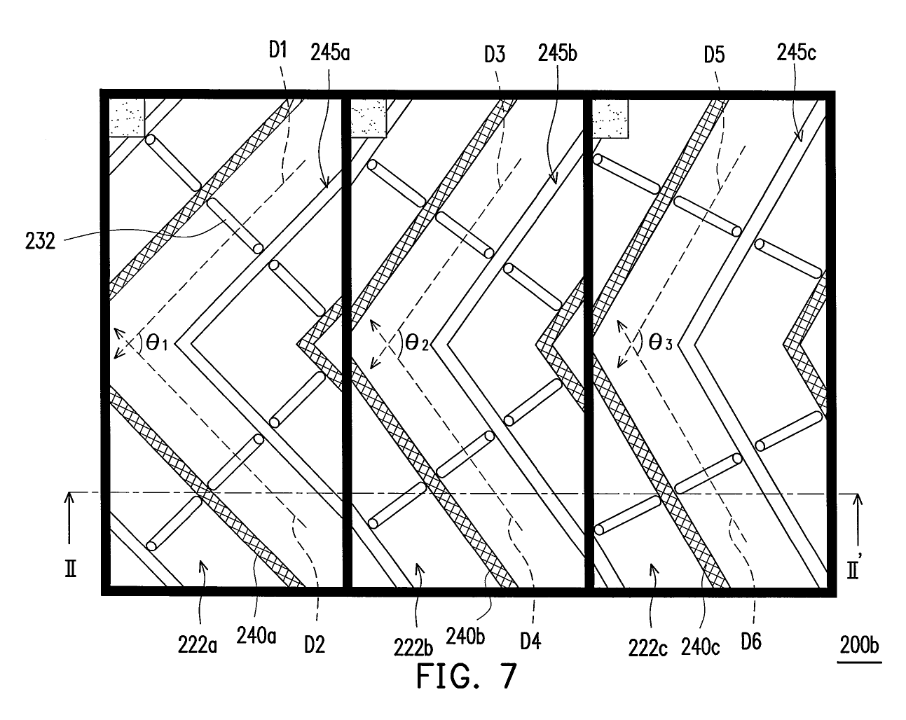

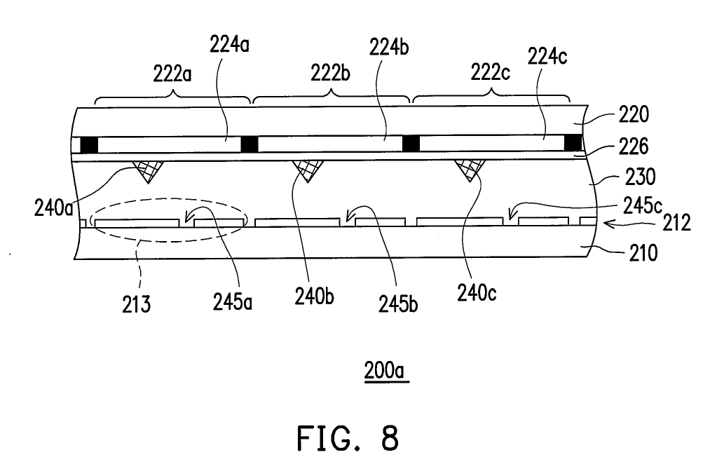

FIG. 7 is a top view schematically showing a single pixel of the LCD panel according to the second embodiment of the present invention, and FIG. 8 schematically shows a cross-sectional view taken along the line II-II′ in FIG. 7. Referring to FIGS. 7 and 8, the LCD panel 200b in the present embodiment is similar to the LCD panel 200 in the first embodiment and only the differences between them are described below. In the LCD panel 200b of this embodiment, the first alignment patterns are disposed in the first sub-pixel regions 222a of the second substrate 220 and the regions on the first substrate 210 which is opposite to the first sub-pixel regions 222a of the second substrate 220 along the first direction D1 and the second direction D2. Likewise, the second alignment patterns are disposed in the second sub-pixel regions 222b of the second substrate 220 and the regions on the first substrate 210 which is opposite to the second sub-pixel regions 222b of the second substrate 220 along the third direction D3 and the fourth direction D4. Similarly, the third alignment patterns are disposed in the third sub-pixel regions 222c of the second substrate 220 and the regions on the first substrate 210 which is opposite to the third sub-pixel regions 222c of the second substrate 220 along the fifth direction D5 and the sixth direction D6.

For example, the first alignment pattern may include the protrusion 240a and the slit 245a, the second alignment pattern may include the protrusion 240b and the slit 245b, and the third alignment pattern may include the protrusion 240c and the slit 245c. Here, the protrusions 240a, 240b and 240c for example are disposed on the second transparent electrode layer 226 of the second substrate 220, and the slits 245a, 245b and 245c for example are formed inside the first transparent electrode layer 212 of the first substrate 210. Additionally, the first transparent electrode layer 212 may be a patterned transparent electrode layer and include a plurality of pixel electrodes 213. The material of this first transparent electrode layer 212 is similar to that of the second transparent electrode layer 226.

It's worthy to note that, the protrusions 240a, 240b and 240c can be disposed on the second transparent electrode layer 212 of the first substrate 210 and the slits 245a, 245b and 245c can be formed in the second transparent electrode layer 226 of the second substrate 220. Besides, the first, the second and the third alignment patterns can merely include the protrusions disposed on the first and the second transparent electrode layers 212 and 226, or include the slits formed in the first and the second transparent electrode layers 212 and 226.

### The Third Embodiment

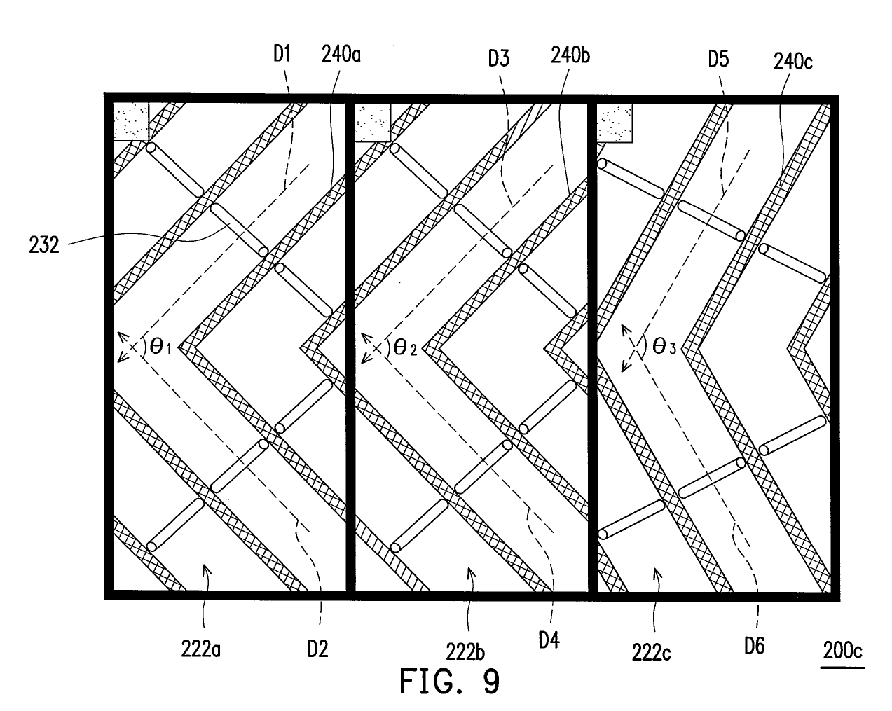

FIG. 9 is a top view schematically showing a single pixel of the LCD panel according to the third embodiment of the present invention. Referring to FIG. 9, the LCD panel 200c in the present embodiment is similar to the LCD panel 200 in the first embodiment and only the differences between them are described below. In this embodiment, the first direction D1 is identical to the third direction D3 and the second direction D2 identical to the fourth direction D4, where θ₁ is equal to θ₂. That is, the color shift for the LCD panel in displaying mid-tone images can also be improved by changing merely the alignment direction of the third alignment patterns (e.g. the protrusions 240c) basing on the present invention.

In summary, the LCD panel according to the present invention is mainly directed to provide different arrangement directions for alignment patterns inside the different sub-pixel regions, so that the liquid crystal molecules corresponding to respective sub-pixel region can be arranged in varied tilt angles. By doing so, different color lights with similar brightness can be produced, in displaying mid-tone images, when the white light passes through different sub-pixel regions. Consequently, the color shift phenomenon can be improved, thereby raising the displaying quality of the LCD.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel, comprising:
a first substrate;
a second substrate, whereon a plurality of first sub-pixel regions, a plurality of second sub-pixel regions, and a plurality of third sub-pixel regions are defined;
a liquid crystal layer disposed between the first substrate and the second substrate;
a plurality of first alignment patterns disposed inside the first sub-pixel regions along a first direction and a second direction wherein the first direction is at an angle θ₁ with the second direction;
a plurality of second alignment patterns disposed inside the second sub-pixel regions along a third direction and a fourth direction wherein the third direction is at an angle θ₂ with the fourth direction and θ₁≦θ₂; and
a plurality of third alignment patterns disposed inside the third sub-pixel regions along a fifth direction and a sixth direction wherein the fifth direction is at an angle θ₃ with the sixth direction, and θ₂<θ₃.

2. The liquid crystal display panel according to claim 1, further comprising:
a plurality of first color filter patterns disposed inside the first sub-pixel regions;
a plurality of second color filter patterns disposed inside the second sub-pixel regions; and
a plurality of third color filter patterns disposed inside the third sub-pixel regions, wherein, the transmission wavelength of the first color filter patterns is greater than the transmission wavelength of the second color filter patterns, and the transmission wavelength of the second color filter patterns is greater than the transmission wavelength of the third color filter patterns.

3. The liquid crystal display panel according to claim 2, wherein the first color filter patterns include red color filter patterns, the second color filter patterns include green color filter patterns, and the third color filter patterns include blue color filter patterns.

4. The liquid crystal display panel according to claim 1, wherein
the first alignment patterns further comprise regions on the first substrate which is opposite to the first sub-pixel regions of the second substrate along the first direction and the second direction;
the second alignment patterns further comprise regions on the first substrate which is opposite to the second sub-pixel regions of the second substrate along the third direction and the fourth direction; and
the third alignment patterns further comprise regions on the first substrate which is opposite to the third sub-pixel regions of the second substrate along the fifth direction and the sixth direction.

5. The liquid crystal display panel according to claim 4, wherein the first substrate further comprises a first transparent electrode layer disposed thereon and the second substrate further comprises a second transparent electrode layer disposed thereon, and the first, the second and the third alignment patterns respectively comprising a plurality of protrusions disposed on the first transparent electrode layer and a plurality of slits formed in the second transparent electrode layer.

6. The liquid crystal display panel according to claim 4, wherein the first substrate further comprises a first transparent electrode layer disposed thereon and the second substrate further comprises a second transparent electrode layer disposed thereon, and the first, the second and the third alignment patterns respectively comprising a plurality of protrusions disposed on the second transparent electrode layer and a plurality of slits formed in the first transparent electrode layer.

7. The liquid crystal display panel according to claim 4, wherein the first, the second and the third alignment patterns include protrusions.

8. The liquid crystal display panel according to claim 7, wherein the material of the first, the second and the third alignment patterns include color filtering material, transparent photo-sensitive material or the combination thereof.

9. The liquid crystal display panel according to claim 4, wherein the first, the second and the third alignment patterns include slits.

10. The liquid crystal display panel according to claim 1, wherein the first, the second and the third alignment patterns include protrusions.

11. The liquid crystal display panel according to claim 10, the material of the first, the second and the third alignment patterns include color filtering material, transparent photo-sensitive material or the combination thereof.

12. The liquid crystal display panel according to claim 1, wherein the first, the second and the third alignment patterns include slits.

13. The liquid crystal display panel according to claim 1, wherein the angle θ₁ is equal to 90 degrees.

14. The liquid crystal display panel according to claim 1, wherein the angle θ₂ is between 90 degrees and 120 degrees.

15. The liquid crystal display panel according to claim 1, wherein the angle θ₃ is between 110 degrees and 130 degrees.

16. The liquid crystal display panel according to claim 1, wherein the first substrate is a thin film transistor array substrate and the second substrate is a color filter substrate.
